(19) United States
(12) Patent Application Publication
(10) Pub. No.: US 2010/0080209 A1
(43) Pub. Date: Apr. 1, 2010

(54) Radio Synchronization Method, Radio Synchronization System, and Base Station

(75) Inventor: Masaharu Suzuki, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/524,341

(22) PCT Filed: Dec. 19, 2007
(86) PCT No.: PCT/JP2007/074454

§ 371 Date: Sep. 2, 2009

(30) Foreign Application Priority Data
Jan. 23, 2007 (JP) 2007-013074

(51) Int. Cl. H04J 3/06

(52) U.S. Cl. 370/350

(57) ABSTRACT

In a radio synchronization method having a reference base station and a plurality of base stations in a service area, a synchronization executing station executes radio monitor on base stations in a radio monitor range of the synchronization executing base station, selects a base station, which is synchronized with the reference base station in the service area and has a high electric wave intensity, as a synchronization object candidate base station on the basis of the result of radio monitor, requests a peripheral base station in the service area to provide radio monitor information of the synchronization object candidate base station confirms that the synchronization object candidate base station does not undergo synchronization deviation with respect to the reference base station on a basis of radio monitor information, and executes radio synchronization on the synchronization object candidate base station after the confirmation of no synchronization deviation.

### TECHNICAL FIELD

The present invention relates to a technology that, in a communication system having a reference base station and a plurality of base stations in a service area, can prevent synchronization deviation between base stations in the service area so as to suppress a call loss due to synchronization deviation of radio transmission/reception timing to the minimum, thereby improving radio quality and service quality for a user.

### BACKGROUND ART

With respect to synchronization between base stations in a related communication system, in which a reference base station and a plurality of base stations are provided in a service area, when a base station is powered on or reset, the base station is usually synchronized with a base station having a strong electric wave intensity from among the base stations satisfying a synchronization object condition in the service area in order to synchronize with the base stations in the service area.

Next, a related synchronization method will be described with reference to FIG. 3.

Referring to FIG. 3, a reference station, peripheral base stations such as a station A, a station B, a station C, a station D and a station E, and a synchronization executing station for executing synchronization from the peripheral base stations are existed in the service area Z.

Further, a center communication network is constructed between a center S and base stations in order to perform communication between the center S and the base stations.

In such a state, according to the related art, a base station serving as a synchronization object is given priority and selected by following conditions on the basis of the result of radio monitor (i.e., CS-ID for base station identification, electric wave intensity, or the like) of the base stations.

(1) A descending order of the distance from a synchronization reference station provided for each service area or a reference station synchronized with the reference station.

This order is determined on the basis of (CS-ID) information from the result of radio monitor.

(2) A descending order of electric wave intensity.

This order is determined on the basis of electric wave intensity information from the result of radio monitor.

As described above, in the related synchronization method, a base station serving as a synchronization object is selected only on the basis of the result of radio monitor, that is, information about CS-ID and electric wave intensity. A base station that is selected as a synchronization object base station is selected as a synchronization object base station, regardless of presence/absence of synchronization deviation from other base stations or presence/absence of execution of synchronization correction.

Thus, if a base station is synchronized with the selected synchronization object base station but the synchronization object base station is undergoing synchronization deviation as viewed from the entire service area, the base station synchronized with the synchronization object base station also undergoes synchronization deviation when viewed from the entire service area.

With respect to synchronization between the base stations in a PHS communication system, a technology described in Patent Literature 1 is known in which the field intensity of an electric wave is used.

### DISCLOSURE OF THE INVENTION

### Problems that the Invention is to Solve

In the related method that synchronizes a base station with a base station having a strong electric wave intensity from among the base stations satisfying the synchronization object condition in the service area of FIG. 3, even if a base station serving as a synchronization object undergoes synchronization deviation with respect to other base stations when viewed from the entire service area, a base station (synchronization executing station) that executes synchronization does not know the synchronization deviation. For this reason, a group of base stations that undergo synchronization deviation may be formed.

It is an object of the invention to prevent synchronization deviation between base stations in a service area so as to suppress a call loss due to synchronization deviation of radio transmission/reception timing to the minimum, to thereby improve radio quality and service quality for a user. This object is achieved by: obtaining a base station, which is synchronized with a reference base station in a service area and has a high electric wave intensity, as a synchronization object candidate base station on the basis of the result of radio monitor on base stations in a radio monitor range of a synchronization executing station; and executing radio synchronization after it is confirmed that the synchronization object candidate base station does not undergo synchronization deviation with respect to the reference base station by using inter-base-station communication.

### Means for Solving the Problems

In order to solve the problems, there is provided a radio synchronization method in a service area, which includes a reverence base station and a plurality of base stations, the radio synchronization method comprising causing a synchronization executing station that executes radio synchronization to execute the steps of: executing radio monitor on base stations in a radio monitor range of the synchronization executing base station; selecting a base station, which is synchronized with the reference base station in the service area and which has a high electric wave intensity, as a synchronization object candidate base station on the basis of the result of the radio monitor; requesting a peripheral base station in the service area to provide radio monitor information of the synchronization object candidate base station by using inter-base-station communication; confirming that the synchronization object candidate base station does not undergo synchronization deviation with respect to the reference base station on a basis of the radio monitor information as a response to the request from the peripheral base station; and after the confirmation of no synchronization deviation, executing radio synchronization on the synchronization object candidate base station.

Further, the radio synchronization method further comprises a step of, when an existence of a base station which undergoes synchronization deviation with respect to the reference base station is confirmed on the basis of the radio monitor information as a response to the request from the peripheral base station, executing an indication about the necessity for execution of resynchronization with respect to abase station, in which synchronization deviation is confirmed, by using the inter-base-station communication.

Further, there is provided a radio synchronization system comprising: a reference base station and a plurality of base stations in a service area, each of the base stations including a radio monitor unit covering the range of a part of the service area; and an inter-base-station communication unit covering all the base stations in the service area, wherein a synchronization executing station for executing radio synchronization is configured to: execute radio monitor on base stations in a radio monitor range of the synchronization executing base station, and select a base station, which is synchronized with the reference base station of the service area and has a high electric wave intensity, as a synchronization object candidate base station on the basis of the result of radio monitor, request a peripheral base station in the service area to provide radio monitor information of the synchronization object candidate base station by using inter-base-station communication, and confirm synchronization of the synchronization object candidate base station with respect to the reference base station on a basis of the radio monitor information as a response to the request from the peripheral base station, and execute radio synchronization on the synchronization object candidate base station.

Further, in the radio synchronization system, when an existence of a base station which undergoes synchronization deviation with respect to the reference base station is confirmed on the basis of the radio monitor information, an instruction for resynchronization is output to the corresponding base station.

Further, there is provided a base station that executes radio synchronization in a service area, which includes a reference base station and a plurality of base stations, the base station comprising: a radio monitor unit that executes radio monitor on base stations in a radio monitor range from the corresponding base station; a synchronization object candidate base station selecting unit that selects, on a basis of result of the radio monitor, a base station, which is synchronized with the reference base station in the service area and has a high electric wave intensity; a radio monitor information request unit that requests a peripheral base station in the service area to provide radio monitor information of the synchronization object candidate base station by using inter-base-station communication; a synchronization confirming unit that confirms, on the basis of the radio monitor information, that the synchronization object candidate base station does not undergo synchronization deviation with respect to the reference base station; and a synchronization executing unit that executes radio synchronization on the synchronization object candidate base station after the confirmation of synchronization.

Further, the base station further comprises: a resynchronization instruction sending unit that, when an existence of a base station which undergoes synchronization deviation with respect to the reference base station is confirmed, outputs an instruction for resynchronization to a base station, in which synchronization deviation is confirmed, by using the inter-base-station communication.

### ADVANTAGE OF THE INVENTION

According to the inter-base-station synchronization method, the inter-base-station synchronization system, and the base station described in claims 1 to 6, a base station, which is synchronized with the reference base station in the service area and has a high electric wave intensity, is obtained as a synchronization object candidate base station on the basis of the result of radio monitor on the base stations in the radio monitor range of the synchronization executing station, and radio synchronization is executed after it is confirmed that the synchronization object candidate base station does not undergo synchronization deviation with respect to the reference base station by using inter-base-station communication. Therefore, synchronization deviation between the base stations in the service area can be prevented so as to suppress a call loss due to synchronization deviation of radio transmission/reception timing to the minimum. As a result, radio quality and consequently service quality for a user can be improved.

### BRIEF DESCRIPTION OF THE DRAWINGS

FIG. 1 is a diagram showing a radio monitor range (stations B, C, D and E) of a synchronization executing station and a construction of a center communication network between a center S and base stations according to the invention.

FIG. 2 is a diagram showing additional radio monitor range (reference station, and stations A, B, C and E) including a reference station and a peripheral base station A, in addition to the configuration of FIG. 1, and the construction of a center communication network between center S and base stations.

FIG. 3 is a diagram showing a service area Z, a reference station, peripheral base stations such as a station A, a station B, a station C, a station D and a station E, and a synchronization executing station for executing synchronization from the stations in the service area Z.

### DESCRIPTION OF REFERENCE NUMERALS AND SIGNS

S: CENTER

R: ROUTER

Z: SERVICE AREA

A to E: BASE STATION

### BEST MODE FOR CARRYING OUT THE INVENTION

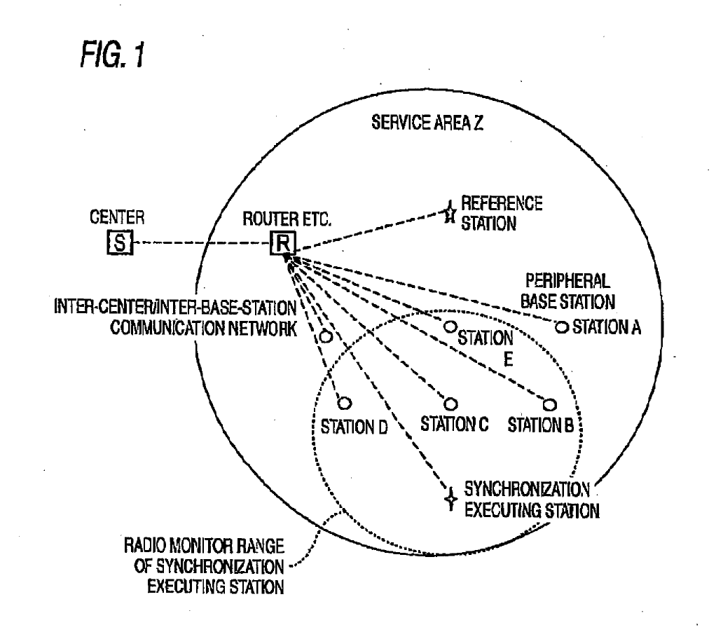

Next, a synchronization method of the invention will be described with reference to FIG. 1.

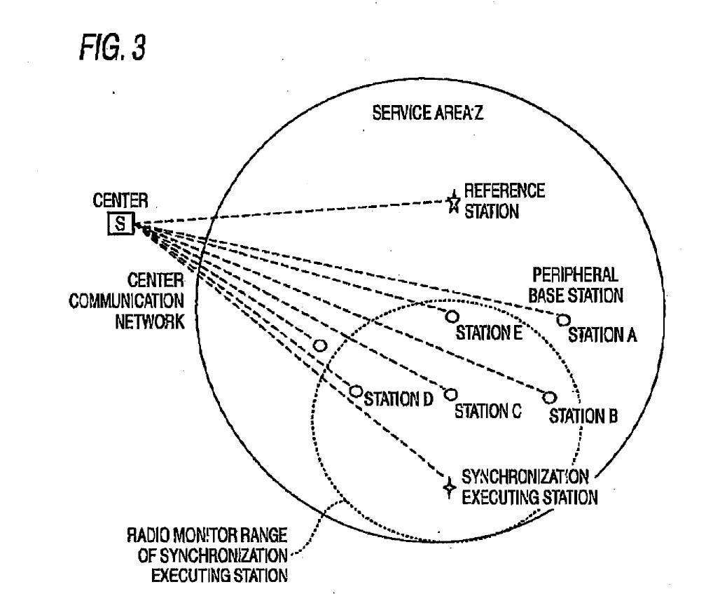

Referring to FIG. 1, similarly to FIG. 3, in a service area A, there are a reference station, peripheral base stations such as a station A, a station B, a station C, a station D and a station E, and a synchronization executing station for executing synchronization from the stations in the service area Z.

FIG. 1 shows the radio monitor range (stations B, C, D and E) of the synchronization executing station. A center communication network is constructed between a center S and the base stations.

In the configuration of FIG. 1, a center communication network is constructed between the center S and the base stations, and an inter-base-station communication network is constructed between the base stations in the service area Z. (Although the configuration of the inter-base-station communication network includes a router R in FIG. 1, the router may not need to be provided.)

In the related synchronization method, a base station serving as a synchronization object is given priority and selected only on the basis of the result of radio monitor (CS-ID and electric wave intensity) of the base stations. In contrast, according to the invention, synchronization is executed on a base station that is given priority and selected by the following conditions on the basis of the result of radio monitor (CS-ID, electric wave intensity, and transmission/reception timing) of the peripheral base stations obtained by inter-base-station communication or resynchronization execution information (i.e., latest synchronization date and time or the like).

(1) An ascending order of the distance from a synchronization reference station provided for each service area or a reference station synchronized with the reference station.

This order is determined by CS-ID from the result of radio monitor or information associated with the CS-ID.

(2) A descending order of electric wave intensity.

This order is determined by electric wave intensity information from the result of radio monitor.

(3) An ascending order of possibility of synchronization deviation when viewed from the entire service area.

This order is determined by CS-ID from the result of radio monitor of other base stations, transmission/reception timing information, and resynchronization execution information obtained by inter-base-station communication.

It can be confirmed that the synchronization deviation of a base station selected as a synchronization object by the conditions (1) and (2) is monitored with transmission timing with transmission/reception timing of radio monitor information of a plurality of other base stations.

Further, if the resynchronization execution time of a base station serving as an information source is the most recent, the possibility of synchronization deviation of a base station serving as a synchronization object may be further reduced.

If the condition (3) is further met, there is a reduction in the probability that a base station is synchronized with another base station, which undergoes synchronization deviation.

With this determination, resynchronization can be requested on a base station that is likely to undergo synchronization deviation. Therefore, a service area with a small radio synchronization deviation can be formed. As a result, radio quality and consequently, service quality for a user can be improved.

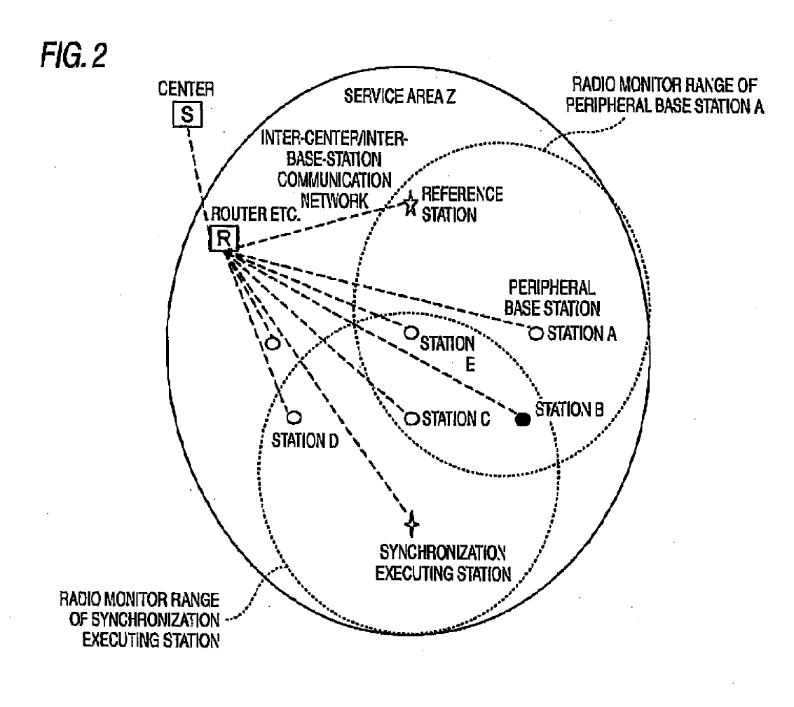

Next, a synchronization method according to a specific example of the invention will be described with reference FIG. 2.

Referring to FIG. 2, like FIG. 1, in a service area A, there are a reference station, peripheral base stations such as a station A, a station B, a station C, a station D and a station E, and a synchronization executing station for executing synchronization from the stations in the service area Z.

FIG. 2 shows the radio monitor ranges (the synchronization executing station, and the stations B, C, D and E) and (the stations A, B, C and E, and the reference station) of the synchronization executing station and of the peripheral base station A.

A center communication network is constructed between a center S and the base stations.

In the configuration of FIG. 2, similarly to FIG. 1, a center communication network is constructed between a center S and the base stations, and an inter-base-station communication network is constructed between the base stations in the service area Z. (Although the configuration of the inter-base-station communication network includes a router R in FIG. 1, a router may not need to be provided.)

In the example of FIG. 2, on the basis of information about the result of radio monitor (CS-ID, electric wave intensity, and transmission/reception timing) of the corresponding base station from other base stations synchronized by inter-base-station communication, it is determined whether or not a base station is synchronized with a base station (synchronization object candidate base station) serving as a synchronization object at the time of radio synchronization, which is executed when the synchronization executing station is powered on or reset.

Accordingly, a base station with normal synchronization is selected as a synchronization partner, and radio synchronization is executed.

When a base station that undergoes synchronization deviation is found, synchronization deviation is notified to the corresponding base station and resynchronization is requested.

Hereinafter, a detailed procedure will be described.
In order to execute radio synchronization, the synchronization executing station executes radio monitor on the base stations in the radio monitor range of the synchronization executing station.
The synchronization executing station sets a base station, which is synchronized with the reference station and has the strongest electric wave intensity, as a synchronization object candidate base station on the basis of the result of radio monitor. (In FIG. 2, the station B is set as a synchronization object candidate base station.)
The synchronization executing station requests the base stations in the service area Z to provide radio monitor information of the synchronization object candidate base station (base station B) by using inter-base-station communication.
A base station (for example, base station A) that has the radio monitor information of the synchronization object candidate base station (base station B) provides information about the synchronization object candidate base station (base station B) to the synchronization executing station by using inter-base-station communication in response to the request.
The radio monitor information from the base station A includes information (CS-ID, electric wave intensity, and transmission/reception timing) about the reference station, the base station A, the base station B, the base station C, and the base station E, which exist in the radio monitor range of the base station A. Therefore, the synchronization executing station that receives the provided information can determine whether or not the synchronization object candidate base station (base station B) undergoes synchronization deviation with respect to the reference station.
With the above-described determination, when it could be confirmed that the synchronization object candidate base station (base station B) does not undergo synchronization deviation with respect to the reference station, the synchronization executing station executes synchronization on the synchronization object candidate base station (base station B).
With the above-described determination, when it could be confirmed that the base station C undergoes synchronization deviation with respect to the reference station, the synchronization executing station requests the base station C to execute resynchronization by using inter-base-station communication.

### INDUSTRIAL APPLICABILITY

According to the inter-base--station synchronization method, the inter-base-station synchronization system, and the base station described in claims 1 to 6, a base station, which is synchronized with the reference base station in the service area and has a high electric wave intensity, is obtained as a synchronization object candidate base station on the basis of the result of radio monitor on the base stations in the radio monitor range of the synchronization executing station, and radio synchronization is executed after it is confirmed that the synchronization object candidate base station does not undergo synchronization deviation with respect to the reference base station by using inter-base-station communication. Therefore, synchronization deviation between the base stations in the service area can be prevented so as to suppress a call loss due to synchronization deviation of radio transmission/reception timing to the minimum. As a result, radio quality and consequently service quality for a user can be improved. Therefore, industrial applicability is very high.

1. A radio synchronization method in a service area, which includes a reference base station and a plurality of base stations, the radio synchronization method comprising causing a synchronization executing station that executes radio synchronization to execute the steps of:
executing radio monitor on base stations in a radio monitor range of the synchronization executing station;
selecting a base station, which is synchronized with the reference base station in the service area and which has a high electric wave intensity, as a synchronization object candidate base station on the basis of the result of the radio monitor;
requesting a peripheral base station in the service area to provide radio monitor information of the synchronization object candidate base station by using inter base-station communication;
confirming that the synchronization object candidate base station does not undergo synchronization deviation with respect to the reference base station on a basis of the radio monitor information as a response to the request from the peripheral base station; and
after the confirmation of no synchronization deviation, executing radio synchronization on the synchronization object candidate base station.

2. The radio synchronization method according to claim 1, further comprising a step of, when an existence of a base station which undergoes synchronization deviation with respect to the reference base station is confirmed on the basis of the radio monitor information as a response to the request from the peripheral base station, executing an indication about the necessity for execution of resynchronization with respect to a base station, in which synchronization deviation is confirmed, by using the inter-base-station communication.

3. A radio synchronization system comprising:
a reference base station and a plurality of base stations in a service area, each of the base stations including a radio monitor unit covering the range of a part of the service area; and
an inter-base-station communication unit covering all the base stations in the service area,
wherein a synchronization executing station for executing radio synchronization is configured to:
execute radio monitor on base stations in a radio monitor range of the synchronization executing station, and select a base station, which is synchronized with the reference base station of the service area and has a high electric wave intensity, as a synchronization object candidate base station on the basis of the result of radio monitor,
request a peripheral base station in the service area to provide radio monitor information of the synchronization object candidate base station by using inter-base-station communication, and
confirm synchronization of the synchronization object candidate base station with respect to the reference base station on a basis of the radio monitor information as a response to the request from the peripheral base station, and execute radio synchronization on the synchronization object candidate base station.

4. The radio synchronization system according to claim 3,
wherein, when an existence of a base station which undergoes synchronization deviation with respect to the reference base station is confirmed on the basis of the radio monitor information, an instruction for resynchronization is output to the corresponding base station.

5. A base station that executes radio synchronization in a service area, which includes a reference base station and a plurality of base stations, the base station comprising:
a radio monitor unit that executes radio monitor on base stations in a radio monitor range from the corresponding base station;
a synchronization object candidate base station selecting unit that selects, on a basis of result of the radio monitor, a base station, which is synchronized with the reference base station in the service area and has a high electric wave intensity;
a radio monitor information request unit that requests a peripheral base station in the service area to provide radio monitor information of the synchronization object candidate base station by using inter-base-station communication;
a synchronization confirming unit that confirms, on the basis of the radio monitor information, that the synchronization object candidate base station does not undergo synchronization deviation with respect to the reference base station; and
a synchronization executing unit that executes radio synchronization on the synchronization object candidate base station after the confirmation of synchronization.

6. The base station according to claim 5, further comprising:
a resynchronization instruction sending unit that, when an existence of a base station which undergoes a synchronization deviation with respect to the reference base station is confirmed, outputs an instruction for resynchronization to a base station, in which synchronization deviation is confirmed, by using the inter-base-station communication.
